(19) United States
(12) Patent Application Publication
(10) Pub. No.: US 2021/0139754 A1
(43) Pub. Date: May 13, 2021

(54) PHOTOCURABLE ADHESIVE SHEET, LAMINATE FOR IMAGE DISPLAY DEVICE, AND IMAGE DISPLAY DEVICE

(71) Applicant: Mitsubishi Chemical Corporation, Tokyo (JP)

(72) Inventors: Kahoru ISHII, Tokyo (JP); Daiki NOZAWA, Tokyo (JP); Makoto INENAGA, Tokyo (JP)

(73) Assignee: Mitsubishi Chemical Corporation, Tokyo (JP)

(21) Appl. No.: 17/152,954

(22) Filed: Jan. 20, 2021

Related U.S. Application Data
(63) Continuation of application No. PCT/JP2019/031228, filed on Aug. 7, 2019.

(30) Foreign Application Priority Data
Aug. 9, 2018 (JP) 2018-150436

(51) Int. Cl. C09J 151/06; C09J 175/06; C09J 11/06; C09J 7/38; C09J 4/06; B32B 7/12

(52) U.S. Cl. CPC C09J 151/06; C09J 175/06; C09J 11/06; C09J 7/385; B32B 2457/208; B32B 7/12; C09J 2433/00; C09J 2475/00; B32B 2307/42; C09J 4/06

(57) ABSTRACT

To provide a photocurable adhesive sheet having both followability to steps and dimensional stability, also having durability after being bonded to a member to be bonded and capable of preventing flowing or foaming even when the member to be bonded has light shielded portions such as printed portions. A photocurable adhesive sheet formed from a photocurable adhesive composition containing a (meth)acrylic copolymer (A), a cross-linking agent (B) other than a photo-crosslinking agent, a photo-crosslinking agent (C) and a photoinitiator (D), wherein the photocurable adhesive sheet has a loss tangent (Tan δ) at a temperature of 90° C. of 0.9 or more.

### TECHNICAL FIELD

The present invention relates to a photocurable adhesive sheet having excellent followability to steps including printed portions and dimensional stability, and a laminate for an image display device and an image display device using the photocurable adhesive sheet.

### BACKGROUND ART

In recent years, to improve visibility of image display devices, the space between an image display screen such as a liquid crystal display (LCD), a plasma display (PDP) or an electroluminescence display (ELD) and a protection screen or a touch screen member arranged in front of it (on the viewing side) has been filled with, for example, an adhesive sheet or liquid adhesive to suppress reflection of incident light or light emitted from an displayed image on the air-layer interface.

As a method for filling spaces between members constituting an image display device with an adhesive, Patent Literature 1, for example, discloses a method in which after filling such a space with a liquid adhesive resin composition containing ultraviolet curable resin, the resin is cured by irradiating it with ultraviolet light.

Furthermore, a method of filling spaces between members constituting an image display device using an adhesive sheet is also known. For example, Patent Literature 2 discloses a method for producing a laminate for configuring an image display device having a constitution in which an image display device-constituting member is layered on at least one side of a transparent double-sided adhesive sheet, wherein after attaching an adhesive sheet which has been primarily cross-linked using ultraviolet light to the image display device-constituting member, the adhesive sheet is secondarily cured by irradiating it with ultraviolet light through the image display device-constituting member.

Furthermore, Patent Literature 3 discloses a method in which members constituting an image display device are stuck using an adhesive sheet comprising an adhesive resin composition containing an acrylic copolymer (A) comprising a graft copolymer comprising a macromonomer as a branch component, a crosslinking agent (B) other than photo-crosslinking agent and a photo-polymerization initiator (C), and then the adhesive resin composition is cross-linked by irradiating it with an active energy ray through the members constituting an image display device, thereby bonding the members constituting an image display device.

### CITATION LIST

### Patent Literature

[Patent Literature 1] International Publication No. WO 2010/027041

[Patent Literature 2] Japanese Patent No. 4971529

[Patent Literature 3] International Publication No. WO 2015/137178

### SUMMARY OF INVENTION

### Technical Problem

A frame-shaped masking layer is often printed on the periphery of a surface protection screen constituting an image display device. Adhesive sheets for bonding constituent members with such a printed portion need to have followability to steps, which is to follow steps including printed portions so that every step is filled therewith, and also need to have high flowability not to cause distortion or deformation in the adhesive sheet.

On the other hand, when an adhesive sheet has extremely high flowability, an adhesive is likely to stick out from edges of a rolled adhesive sheet (adhesive sheet roll) before cutting or a chip product after cutting (an article obtained by cutting adhesive sheet). Thus, adhesive sheets also need to have appropriate dimensional stability.

Moreover, with thinning and lightweight of image display devices, materials of surface protection screens have been changed to a plastic plate such as an acrylic plate and a polycarbonate plate from conventional glass plates.

When a surface protection screen is made of a plastic plate, and when a laminate of the plastic plate and an adhesive sheet is exposed to a high temperature and high humidity condition, foam may be formed in the vicinity of steps, or outgas may be generated in the plastic plate to cause foaming, lifting, peeling and the like. Thus, durability after bonding to a member to be bonded also needs to be high.

In particular, when a member to be bonded is bonded using a photocurable adhesive sheet, the photocurable adhesive sheet is cured (cross-linked) with the photocurable adhesive sheet being inserted between members to be bonded (members constituting an image display device) by irradiating the photocurable adhesive sheet with light through the members to be bonded (members constituting an image display device); thus, if there are printed portions and the like in the member to be bonded, the printed portions may prevent light from reaching the photocurable adhesive sheet and thus the adhesive sheet may not be sufficiently cured, and the sheet may flow or foam when exposed to, for example, a high temperature and high humidity condition.

Accordingly, an object of the present invention is to provide a photocurable adhesive sheet having both followability to steps and dimensional stability, also having durability after being bonded to a member to be bonded and capable of preventing flowing or foaming even when the member to be bonded has a light shielded portion such as a printed portion and a laminate for an image display device and an image display device using the same.

### Solution to Problem

The present invention provides a photocurable adhesive sheet comprising a photocurable adhesive composition comprising a (meth)acrylic copolymer (A), a cross-linking agent (B) other than a photo-crosslinking agent, a photo-crosslinking agent (C) and a photoinitiator (D), wherein the photocurable adhesive sheet has a loss tangent (Tan δ) at a temperature of 90° C. of 0.9 or more.

The present invention also provides a photocurable adhesive sheet comprising a photocurable adhesive composition comprising a (meth)acrylic copolymer (A), a photo-crosslinking agent (C) and a photoinitiator (D), wherein the photocurable adhesive sheet has a chemically cross-linked structure and has a loss tangent (Tan δ) at a temperature of 90° C. of 0.9 or more.

### Advantageous Effect of Invention

The photocurable adhesive sheet provided by the present invention has a loss tangent (Tan δ) at a temperature of 90° C. of 0.9 or more, and thus can exhibit excellent followability to steps. At the same time, the (meth)acrylic copolymer (A) reacts with the cross-linking agent (B) other than a photo-crosslinking agent to form a cross-linked structure in the adhesive sheet, and/or the cross-linking agent (B) other than a photo-crosslinking agent reacts with the photo-crosslinking agent (C) to form a cross-linked structure in the adhesive sheet. Furthermore, in that case the photoinitiator (D) can maintain photoactivity, i.e., photo curability.

Thus, the cross-linked structure can not only provide dimensional stability but also prevent flowing or foaming even when members to be bonded have a light shielded portion such as a printed portion.

Furthermore, since the photocurable adhesive sheet can be photocured by layering the photocurable adhesive sheet provided by the present invention between members to be bonded and irradiating the resultant with light, durability after bonding to members to be bonded can be increased.

### DESCRIPTION OF EMBODIMENTS

Next the present invention will be described with reference to embodiments. However, the present invention is not limited to the embodiments described below.

### <<Present Adhesive Sheet>>

The photocurable adhesive sheet according to an embodiment of the present invention (referred to as the present adhesive sheet) comprises a photocurable adhesive composition (referred to as the present photocurable adhesive composition) comprising a (meth)acrylic copolymer (A), a cross-linking agent (B) other than a photo-crosslinking agent, a photo-crosslinking agent (C) and a photoinitiator (D), and is a photocurable double-sided adhesive sheet.

The present adhesive sheet may have a single layer structure with only a layer formed of the present adhesive composition, or may have a multiple layer structure also with the other layers. In the case where the present adhesive sheet has a multiple layer structure, it is preferable that the outermost layer, which is the front layer or the rear layer, is photocurable.

In the present invention “photocurable” means properties of being cured by irradiation with light, and specifically, properties of being cured by irradiation with light having any wavelength region in the region of wavelength of 200 nm to 780 nm, for instance. In particular, having properties of being cured by irradiation with light having any wavelength regions in the region of wavelength of 280 nm to 430 nm is preferred.

### <Present Adhesive Composition>

The present adhesive composition comprises a (meth)acrylic copolymer (A) as a main resin component, and a cross-linking agent (B) other than a photo-crosslinking agent, a photo-crosslinking agent (C) and a photoinitiator (D), and other components as needed.

In the present invention, the “main resin component” means a resin having the highest mass ratio in the resin composition forming the respective layers. Other resins may be included to the extent that does not inhibit the function of the main resin component. The ratio of the content of the main resin component accounts for 50% by mass or more, preferably 70% by mass or more, and particularly preferably 90% by mass or more (100% inclusive) of the resin constituting the respective layers.

Furthermore, the “(meth)acrylic” in the present invention collectively means acrylic and methacrylic, “(meth)acryloyl” means acryloyl and methacryloyl, and “(meth)acrylate” means acrylate and methacrylate, respectively. The “(co)polymer” collectively means polymer and copolymer.

### <(Meth)Acrylic Copolymer (A)>

It is preferable that the (meth)acrylic copolymer (A) is a (meth)acrylic copolymer which contains 50% by mass or more of a structural unit represented by the following formula 1.

In the following formula 1, R₁ represents a hydrogen atom or a methyl group, and R₂ represents a linear or branched alkyl group having 4 to 18 carbon atoms.

[Formula 1]

CH₂═CH(R₁)—COO(R₂) Formula 1

As the above (meth)acrylic copolymer (A), a copolymer containing 50% by mass or more of a structural unit represented by the above formula 1, i.e., a monomer component, is preferred, from the viewpoint of ensuring flexibility and step absorbing properties of the adhesive sheet, and a copolymer containing 55% by mass or more of the monomer component is more preferred, and a copolymer containing 60% by mass or more of the monomer component is particularly preferred from the same viewpoint.

Examples of the monomers represented by the above formula 1 include n-butyl (meth)acrylate, isobutyl (meth)acrylate, sec-butyl (meth)acrylate, t-butyl (meth)acrylate, pentyl (meth)acrylate, isopentyl (meth)acrylate, neopentyl (meth)acrylate, hexyl (meth)acrylate, cyclohexyl (meth)acrylate, heptyl (meth)acrylate, 2-ethylhexyl (meth)acrylate, 2-ethylhexyl EO-modified (meth)acrylate, n-octyl (meth)acrylate, isooctyl (meth)acrylate, nonyl (meth)acrylate, isononyl (meth)acrylate, t-butylcyclohexyl (meth)acrylate, decyl (meth)acrylate, isodecyl (meth)acrylate, undecyl (meth)acrylate, lauryl (meth)acrylate, tridecyl (meth)acrylate, tetradecyl (meth)acrylate, cetyl (meth)acrylate, stearyl (meth)acrylate, isostearyl (meth)acrylate, isobornyl (meth)acrylate, 3,5,5-trimethylcyclohexane (meth)acrylate, dicyclopentanyl (meth)acrylate, dicyclopentenyl (meth)acrylate and dicyclopentenyloxyethyl (meth)acrylate. One of them may be used or two or more of them may be used in combination. One of them may be used or two or more of them may be used in combination.

Among them, one or more of butyl (meth)acrylate, 2-ethylhexyl (meth)acrylate and lauryl (meth)acrylate are particularly preferably included.

The above (meth)acrylic copolymer contains a “other copolymerizable monomer” other than the above monomer component.

Examples of the other copolymerizable monomers include (a) carboxyl group-containing monomers (hereinafter may also be referred to as “copolymerizable monomer A”), (b) hydroxyl group-containing monomers (hereinafter may also be referred to as “copolymerizable monomer B”), (c) amino group-containing monomers (hereinafter may also be referred to as “copolymerizable monomer C”), (d) epoxy group-containing monomers (hereinafter may also be referred to as “copolymerizable monomer D”), (e) amide group-containing monomers (hereinafter may also be referred to as “copolymerizable monomer E”), (f) vinyl monomers (hereinafter may also be referred to as “copolymerizable monomer F”), (g) (meth)acrylate monomers with a side chain having 1 to 3 carbon atoms (hereinafter may also be referred to as “copolymerizable monomer G”), (h) macromonomers (hereinafter may also be referred to as “copolymerizable monomer H”), (i) aromatic group-containing monomers (hereinafter may also be referred to as “copolymerizable monomer I”) and (j) other functional group-containing monomers (hereinafter may also be referred to as “copolymerizable monomer J”). One of them may be used or two or more of them may be used in combination.

Among them, copolymerizable monomers A, B and C are particularly preferred from the viewpoint of formation of a cross-linked structure. Hydrophilic (meth)acrylate monomers are particularly preferred from the viewpoint of prevention of whitening due to heat and humidity and enhancement of adhesiveness to members to be bonded.

Furthermore, the above “other copolymerizable monomers” are included in the above (meth)acrylic copolymer at a ratio of preferably 1 to 30% by mass, and more preferably 2% by mass or more and 25% by mass or less.

Examples of the above copolymerizable monomers A include (meth)acrylic acid, carboxyethyl (meth)acrylate, carboxypropyl (meth)acrylate, carboxybutyl (meth)acrylate, ω-carboxypolycaprolactone mono(meth)acrylate, 2-(meth)acryloyloxyethyl hexahydrophthalic acid, 2 (meth)acryloyloxypropyl hexahydrophthalic acid, 2-(meth)acryloyloxyethyl phthalic acid, 2-(meth)acryloyloxypropyl phthalic acid, 2-(meth)acryloyloxyethyl maleic acid, 2-(meth)acryloyloxypropyl maleic acid, 2-(meth)acryloyloxyethyl succinic acid, 2-(meth)acryloyloxypropyl succinic acid, crotonic acid, fumaric acid, maleic acid and itaconic acid. One of them may be used or two or more of them may be used in combination.

Examples of the above copolymerizable monomers B include hydroxyalkyl (meth)acrylates such as 2-hydroxyethyl (meth)acrylate, 2-hydroxypropyl (meth)acrylate, 3-hydroxypropyl (meth)acrylate and 2-hydroxybutyl (meth)acrylate. One of them may be used or two or more of them may be used in combination.

Examples of the above copolymerizable monomers C include aminoalkyl (meth)acrylates such as aminomethyl (meth)acrylate, aminoethyl (meth)acrylate, aminopropyl (meth)acrylate and aminoisopropyl (meth)acrylate, N-alkylaminoalkyl (meth)acrylates, and N,N-dialkylaminoalkyl (meth)acrylates such as N,N-dimethylaminoethyl (meth)acrylate and N,N-dimethylaminopropyl (meth)acrylate. One of them may be used or two or more of them may be used in combination.

Examples of the above copolymerizable monomers D include glycidyl (meth)acrylate, methylglycidyl (meth)acrylate, 3,4-epoxycyclohexylmethyl (meth)acrylate and 4-hydroxybutyl (meth)acrylate glycidyl ether. One of them may be used or two or more of them may be used in combination.

Examples of the above copolymerizable monomers E include (meth)acrylamide, N,N-dimethyl (meth)acrylamide, N-butyl (meth)acrylamide, N-methylol (meth)acrylamide, N-methylolpropane (meth)acrylamide, N-methoxymethyl (meth)acrylamide, N-butoxymethyl (meth)acrylamide, diacetone (meth)acrylamide, maleic acid amide and maleimide. One of them may be used or two or more of them may be used in combination.

Examples of the above copolymerizable monomers F include compounds having a vinyl group in the molecule. Examples of such compounds include (meth)acrylic acid alkyl esters in which the alkyl group has 1 to 12 carbon atoms, functional monomers having a functional group such as a hydroxyl group, an amide group and an alkoxyl alkyl group, polyalkylene glycol di(meth)acrylates, vinyl ester monomers such as vinyl acetate, N-vinyl-2-pyrrolidone, vinyl propionate and vinyl laurate, and aromatic vinyl monomers such as styrene, chlorostyrene, chloromethyl styrene, α-methylstyrene and other substituted styrenes. One of them may be used or two or more of them may be used in combination.

Examples of the above copolymerizable monomers G include methyl (meth)acrylate, ethyl (meth)acrylate, n-propyl (meth)acrylate and i-propyl (meth)acrylate. One of them may be used or two or more of them may be used in combination.

The macromonomer as the above copolymerizable monomer H is a high molecular weight monomer having a functional group at the terminal and a high molecular weight skeleton component. A monomer which provides a side chain having 20 or more carbon atoms when a (meth)acrylic ester copolymer is formed by polymerization is preferred.

Use of copolymerizable monomer H allows a macromonomer to be introduced into a copolymer as a branch component and thus a (meth)acrylic ester copolymer in the form of a graft copolymer can be formed. For example, a (meth)acrylic copolymer (A) comprising a graft copolymer having a macromonomer as a branch component may be formed.

Thus, characteristics of the main chain and the side chain of a graft copolymer may be changed by selecting copolymerizable monomer H and monomers other than that, and the mixing ratio thereof.

It is preferable that the skeleton component of the above macromonomer is composed of an acrylic ester polymer or a vinyl polymer. Examples thereof include a linear or branched alkyl (meth)acrylate whose side chain has 4 to 18 carbon atoms, and those listed as examples of the above copolymerizable monomers A, the above copolymerizable monomers B, and the above copolymerizable monomers G. These may be used singly or two or more of them may be used in combination.

Examples of the above copolymerizable monomers I include benzyl (meth)acrylate, phenoxyethyl (meth)acrylate, 2-hydroxy-3-phenoxypropyl (meth)acrylate and nonylphenol EO-modified (meth)acrylate. One of them may be used or two or more of them may be used in combination.

Examples of the above copolymerizable monomers J include (meth)acrylic-modified silicone, and fluorine-containing monomers such as 2,2,2-trifluoroethyl (meth)acrylate, 2,2,3,3-tetrafluoropropyl (meth)acrylate, 1H,1H,5H-octafluoropentyl (meth)acrylate and 1H,1H,2H,2H-tridecafluoro-n-octyl (meth)acrylate. One of them may be used or two or more of them may be used in combination.

<Cross-Linking Agent (B) Other than Photo-Crosslinking Agent>

When the present adhesive composition contains a cross-linking agent (B) other than a photo-crosslinking agent, a cross-linked structure can be formed in the present adhesive sheet. More specifically, a chemically cross-linked structure including a covalent bond and an ionic bond can be formed by the reaction of the cross-linking agent (B) and cross-linkable functional groups existing in the molecule of the (meth)acrylic copolymer (A).

### (Isocyanate Compound (B1))

Next, the cross-linking agent (B) will be described, mainly illustrating an isocyanate compound (referred to as isocyanate compound (B1)) as an example of cross-linking agents (B).

When the present adhesive composition contains a compound having an isocyanate group (referred to as an “isocyanate compound”), a cross-linked structure can be formed in the present adhesive sheet. More specifically, a chemically cross-linked structure including a covalent bond and an ionic bond can be formed by the reaction of the isocyanate compound (B1) and cross-linkable functional groups existing in the molecule of the (meth)acrylic copolymer (A).

Furthermore, when the photo-crosslinking agent (C) has a functional group which reacts with the isocyanate compound (B1), for example, one or more functional groups selected from the group consisting of a hydroxyl group, a carboxyl group and an amino group, a chemically cross-linked structure can be formed by the reaction of the isocyanate compound (B1) and the photo-crosslinking agent (C).

Examples of the above isocyanate compounds (B1) include 2,4-tolylene diisocyanate, 2,6-tolylene diisocyanate, hydrogenated tolylene diisocyanate, 1,3-xylylene diisocyanate, 1,4-xylylene diisocyanate, hexamethylene diisocyanate, diphenylmethane-4,4-diisocyanate, isophorone diisocyanate, 1,3-bis(isocyanatomethyl)cyclohexane, tetramethylxylylene diisocyanate, 1,5-naphthalene diisocyanate and triphenylmethane triisocyanate.

An adduct of such an isocyanate compound (B1) and a polyol compound such as trimethylolpropane, and a biuret product and an isocyanurate product of these polyisocyanate compounds may also be used.

Aliphatic isocyanate and a biuret product thereof are particularly preferred because they have excellent pot life, compatibility with resin and durability.

From the viewpoint of ensuring pot life, blocked isocyanate is particularly preferred, in which isocyanate groups are protected by a blocking agent including a phenol compound, a caprolactam compound, an oxime compound such as methyl ethyl ketone oxime, an active methylene compound and dimethylpyrazole, or a blocking agent composed of two or more of them.

Examples of cross-linking agents (B) which can be used in the present adhesive composition instead of the above isocyanate compounds (B1) include epoxy group-containing compounds such as ethylene glycol diglycidyl ether, polyethylene glycol diglycidyl ether, polypropylene glycol diglycidyl ether, trimethylolpropane polyglycidyl ether and pentaerythritol polyglycidyl ether, ethylene amine compounds such as ethylene diamine, diethylene triamine, triethylene tetramine, tetraethylene pentamine, pentaethylene hexamine, piperazine and aminoethylpiperazine, aziridine compounds, carbodiimide compounds, triazine compounds, oxetane group-containing compounds, oxazoline group-containing compounds, urea cross-linking agents, metal salt cross-linking agents, metal chelate cross-linking agents, amino resin cross-linking agents, metal alkoxide cross-linking agents and peroxide cross-linking agents. One of these compounds may be used or two or more of them may be used in combination.

These compounds may be used instead of the isocyanate compound, and thus the isocyanate compound in the following description may be replaced with these compounds.

When the content of the above isocyanate compound (B1) is too low, the effect of adding the isocyanate compound cannot be obtained, and when the content is too high, the pot life of the adhesive resin composition is reduced and flexibility of the adhesive sheet is decreased. The ratio of the isocyanate compound (B) is 0.001 part by mass or more and 10 parts by mass or less, preferably 0.05 part by mass or more and 5 parts by mass or less, and more preferably 0.1 part by mass or more and 3 parts by mass or less based on 100 parts by mass of the (meth)acrylic copolymer (A) from the above viewpoint. The same applies to the cross-linking agent (B) other than the isocyanate compound (B1), and the isocyanate compound (B1) shall be deemed to be replaced with the cross-linking agent (B) other than the isocyanate compound (B1).

### <Photo-Crosslinking Agent (C)>

The photo-crosslinking agent is a compound which can form a cross-linked structure in the present adhesive sheet by the reaction caused by light.

Examples of photo-crosslinking agents (C) include photo-polymerizable compounds, more specifically compounds having a carbon-carbon double bond in the molecule, in particular, a monomer component or an oligomer component having a carbon-carbon double bond in the molecule. Among them, multifunctional monomers having two or more carbon-carbon double bonds in the molecule are preferred.

By using a multifunctional monomer, not only a chemically cross-linked structure, which is a three-dimensional net structure formed by chemical bonding of multifunctional monomers, can be formed, but also a chain (meth)acrylic copolymer is entangled in the three-dimensional net structure to constrain the movement of polymer to form a physical aggregate structure, i.e., a physically cross-linked structure.

Examples of the above multifunctional monomers include ultraviolet curable multifunctional (meth)acrylic monomers such as 1,4-butanediol di(meth)acrylate, glycerol di(meth)acrylate, neopentyl glycol di(meth)acrylate, glycerol glycidyl ether di(meth)acrylate, 1,6-hexanediol di(meth)acrylate, 1,9-nonanediol di(meth)acrylate, tricyclodecane dimethacrylate, tricyclodecane dimethanol di(meth)acrylate, bisphenol A polyethoxy di(meth)acrylate, bisphenol A polypropoxy di(meth)acrylate, bisphenol F polyethoxy di(meth)acrylate, ethylene glycol di(meth)acrylate, neopentyl glycol di(meth)acrylate, trimethylol propane trioxyethyl (meth)acrylate, ε-caprolactone-modified tris(2-hydroxyethyl)isocyanurate tri(meth)acrylate, pentaerythritol tri(meth)acrylate, propoxylated pentaerythritol tri(meth)acrylate, ethoxylated pentaerythritol tetra(meth)acrylate, pentaerythritol tetra(meth)acrylate, propoxylated pentaerythritol tetra(meth)acrylate, ethoxylated pentaerythritol tetra(meth)acrylate, dipentaerythritol hexa(meth)acrylate, polyethylene glycol di(meth)acrylate, tris(acryloxyethyl)isocyanurate, dipentaerythritol hexa(meth)acrylate, dipentaerythritol penta(meth)acrylate, tripentaerythritol hexa(meth)acrylate, tripentaerythritol penta(meth)acrylate, neopentylglycol hydroxypivalate di(meth)acrylate, di(meth)acrylate of ε-caprolactone adduct of neopentylglycol hydroxypivalate, trimethylolpropane tri(meth)acrylate, trimethylolpropane polyethoxy tri(meth)acrylate and ditrimethylolpropane tetra(meth)acrylate, and multifunctional (meth)acrylic oligomers such as polyester (meth)acrylate, epoxy (meth)acrylate, urethane (meth)acrylate and polyether (meth)acrylate. One of them may be used or two or more of them may be used in combination.

As described above, from the viewpoint of formation of chemically cross-linked structure by the reaction with the functional group of the cross-linking agent (B), for example, an isocyanate compound (B1), a compound having a functional group which reacts with the isocyanate compound (B1), for example, a compound having one or more functional groups selected from the group consisting of a hydroxyl group, a carboxyl group and an amino group, more specifically a multifunctional (meth)acrylate having one or more functional groups selected from the group consisting of a hydroxyl group, a carboxyl group and an amino group is preferred as the photo-crosslinking agent (C).

Multifunctional (meth)acrylate having such a functional group can form a chemical bond between the functional group and the functional group in the cross-linking agent (B), for example, an isocyanate group in the isocyanate compound (B1), and thus can not only increase cohesive force of the adhesive sheet, but also improve storage stability and dimensional stability.

Examples of such multifunctional (meth)acrylate include glycerol di(meth)acrylate, pentaerythritol tri(meth)acrylate, alkylene glycol-modified pentaerythritol tri(meth)acrylate, dipentaerythritol poly(meth)acrylate, alkylene glycol-modified di-pentaerythritol poly(meth)acrylate, isocyanuric acid EO-modified (meth)acrylate, various epoxy (meth)acrylates prepared by adding (meth)acrylic acid to a glycidyl ether compound and polyester (meth)acrylate.

The adhesive resin composition may also contain a monofunctional monomer in addition to the multifunctional monomer. Containing a monofunctional monomer makes it possible to adjust viscoelastic behavior of the adhesive sheet and improve affinity to the member to be bonded and improve the effect of suppressing whitening due to heat and humidity.

Examples of the monofunctional monomers include alkyl (meth)acrylates such as methyl acrylate, hydroxyl group-containing (meth)acrylates such as hydroxyethyl (meth)acrylate, hydroxypropyl (meth)acrylate, hydroxybutyl (meth)acrylate, glycerol (meth)acrylate and polyalkylene glycol (meth)acrylate; carboxyl group-containing monomers such as (meth)acrylic acid, 2-(meth)acryloyloxyethylhexahydrophthalic acid, 2-(meth)acryloyloxypropylhexahydrophthalic acid, 2-(meth)acryloyloxyethylphthalic acid, 2-(meth)acryloyloxypropylphthalic acid, 2-(meth)acryloyloxyethylmaleic acid, 2-(meth)acryloyloxypropylmaleic acid, 2-(meth)acryloyloxyethylsuccinic acid, 2-(meth)acryloyloxypropylsuccinic acid, crotonic acid, fumaric acid, maleic acid, itaconic acid, monomethyl maleate and monomethyl itaconate; acid anhydride group-containing monomers such as maleic anhydride and itaconic anhydride; ether group-containing (meth)acrylate such as tetrahydrofurfuryl (meth)acrylate and methoxypolyethylene glycol (meth)acrylate; and (meth)acrylamide monomers such as (meth)acrylamide, dimethyl (meth)acrylamide, diethyl (meth)acrylamide, (meth)acryloylmorpholine, hydroxyethyl (meth)acrylamide, isopropyl (meth)acrylamide, dimethylaminopropyl (meth)acrylamide, phenyl (meth)acrylamide, N-t-butyl (meth)acrylamide, N-methylol (meth)acrylamide, N-methoxymethyl (meth)acrylamide, N-butoxymethyl (meth)acrylamide and diacetone (meth)acrylamide.

Among them, hydroxyl group-containing (meth)acrylates and (meth)acrylamide monomers are preferably used from the viewpoint of improvement of the effect of suppressing whitening due to heat and humidity.

Furthermore, the monofunctional (meth)acrylate is preferably a compound having a functional group which reacts with the functional group in the cross-linking agent (B), for example, an isocyanate group in the isocyanate compound (B1), e.g., one or more functional groups selected from the group consisting of a hydroxyl group, a carboxyl group and an amino group, because the cohesive force of the adhesive resin composition can be increased.

When the content of the photo-crosslinking agent (C) is too low, the effect of adding the photo-crosslinking agent, i.e., the effect of achieving a required cross-linking degree, cannot be obtained. When the content is too high, the photo-crosslinking agent is likely to bleed before crosslinking, cohesive force for physical crosslinking may be insufficient, and the adhesive sheet may become too hard after photo-crosslinking and thus may be less step-absorbing. The ratio is preferably 0.5 to 50 parts by mass, more preferably 1 part by mass or more and 40 parts by mass or less, and further preferably 5 parts by mass or more and 30 parts by mass or less based on 100 parts by mass of the (meth)acrylic copolymer from the above viewpoint.

### <Photoinitiator (D)>

The photoinitiator (D) is roughly classified into two based on the mechanism of generating radicals: one is cleavage photoinitiators capable of generating radicals by cleaving and decomposing single bonds in the photoinitiator itself, and the other is hydrogen abstracting photoinitiators in which photo-excited initiator and a hydrogen doner in the system form an excited complex to transfer hydrogen in the hydrogen doner.

The photoinitiator (D) may be any of the cleavage photoinitiators and the hydrogen abstracting photoinitiators, and the respective ones may be used singly, or both may be mixed to be used. Furthermore, one of the respective photoinitiators may be used, or two or more of them may be used in combination.

Examples of the cleavage photoinitiators include 2,2-dimethoxy-1,2-diphenylethan-1-one, 1-hydroxycyclohexylphenylketone, 2-hydroxy-2-methyl-1-phenyl-propan-1-one, 1-(4-(2-hydroxyethoxy)phenyl)-2-hydroxy-2-methyl-1-propan-1-one, 2-hydroxy-1-[4-{4-(2-hydroxy-2-methyl-propionyl)benzyl}phenyl]-2-methyl-propan-1-one, oligo(2-hydroxy-2-methyl-1-(4-(1-methylvinyl)phenyl)propanone), methyl phenylglyoxylate, 2-benzyl-2-dimethylamino-1-(4-morpholinophenyl)butan-1-one, 2-methyl-1-[4-(methylthio)phenyl]-2-morpholinopropan-1-one, 2-(dimethylamino)-2-[(4-methylphenyl)methyl]-1-[4-(4-morpholinyl)phenyl]-1-butanone, bis(2,4,6-trimethylbenzoyl)-phenylphosphine oxide, 2,4,6-trimethylbenzoyl diphenylphosphine oxide, (2,4,6-trimethylbenzoyl)ethoxyphenylphosphine oxide, bis(2,6-dimethoxybenzoyl)2,4,4-trimethylpentylphosphine oxide, and a derivative thereof.

Examples of the hydrogen abstracting photoinitiators include benzophenone, 4-methyl-benzophenone, 2,4,6-trimethylbenzophenone, 4-phenylbenzophenone, 3,3T-dimethyl-4-methoxybenzophenone, 4-(meth)acryloyloxybenzophenone, methyl 2-benzoylbenzoate, methyl benzoylformate, bis(2-phenyl-2-oxoacetic acid)oxybisethylene, 4-(1,3-acryloyl-1,4,7,10,13-pentaoxotridecyl) benzophenone, thioxanthone, 2-chlorothioxanthone, 3-methyl thioxanthone, 2,4-dimethyl thioxanthone, 2-methyl anthraquinone, 2-ethyl anthraquinone, 2-tert-butyl anthraquinone, 2-aminoanthraquinone and a derivative thereof.

The content of the above photoinitiator (D) is not particularly limited. It is preferable that as a guide the photoinitiator (D) is included at a ratio of 0.1 to 10 parts by mass, particularly 0.5 part by mass or more and 5 parts by mass or less, and especially 1 part by mass or more and 3 parts by mass or less based on 100 parts by mass of the (meth)acrylic copolymer (A).

### <Other Components>

The present adhesive composition may contain components other than the above components, i.e., various additives such as a tackifier resin, an antioxidant, a photostabilizer, a metal deactivating agent, an antioxidant, a desiccant, a polymerization inhibitor, a ultraviolet absorber, an anti-corrosive agent, a silane coupling agent and inorganic particles as needed.

A reaction catalyst (e.g., ternary amine compounds, quaternary ammonium compounds and tin laurate compounds) may also be included as needed.

### <Cross-Linked Structure>

It is preferable that the present adhesive sheet has a cross-linked structure.

The present adhesive composition can form a cross-linked structure in the adhesive sheet by reaction of the (meth)acrylic copolymer (A) with the cross-linking agent (B) other than a photo-crosslinking agent to form a cross-linked structure, and/or by reaction of the cross-linking agent (B) other than a photo-crosslinking agent with the photo-crosslinking agent (C) to form a cross-linked structure. Furthermore, in that case the photoinitiator (D) can maintain photoactivity, i.e., photo curability.

The cross-linked structure in the present adhesive sheet can not only provide dimensional stability but also prevent flowing or foaming even when members to be bonded have any light shielded portions such as printed portions.

It is preferable that the cross-linked structure is a physically cross-linked structure and/or a chemically cross-linked structure.

The physically cross-linked structure means (pseudo) crosslinking caused by a non-covalent bond based on a hydrogen bond, electrostatic interaction or interaction such as Van der Waals force in a polymer chain or between polymer chains, not that polymer chains are crosslinked by a chemical bond. By contrast, the chemically cross-linked structure means that polymer chains are cross-linked by a chemical covalent bond.

In contrast to this, the physically cross-linked structure means (pseudo) crosslinking caused by a non-covalent bond of a hydrogen bond, electrostatic interaction or interaction such as Van der Waals force in a polymer chain or between polymer chains, not that polymer chains are crosslinked by a chemical bond.

In the present adhesive sheet, a chemically cross-linked structure is more preferred because the structure has excellent shape retaining properties.

In the physically cross-linked structure, the interaction between polymer chains becomes weak depending on, temperature and pressure and the like, and flowability increases due to an increase in temperature and the like. By contrast, such flowability can be controlled in the chemically cross-linked structure.

To form a physically cross-linked structure, an example is a method of forming a physically cross-linked structure by selecting (meth)acrylic copolymer (A) having a microphase separated structure, such as a graft copolymer having a macromonomer as a branch component, or by selecting a (meth)acrylic copolymer (A) in which (pseudo)cross-linking is caused by a non-covalent bond formed by the interaction in a polymer chain or between polymer chains, such as a graft copolymer having a macromonomer as a branch component. Furthermore, when a multifunctional monomer is used as the photo-crosslinking agent (C), the multifunctional monomer itself is cross-linked to form a three-dimensional net structure, and a chain (meth)acrylic copolymer is entangled in the three-dimensional net structure to form a physically cross-linked structure. The method, however, is not limited thereto.

When the graft copolymer is used as the (meth)acrylic copolymer (A), high affinity stem components and branch components are attracted to each other at room temperature so that the (meth)acrylic copolymer (A) forms a microphase separated structure, and the resin composition (adhesive) can maintain the state in which it is physically cross-linked, enabling the shape to be maintained.

In the present invention, whether physically cross-linked structure is formed by a macromonomer or not can be determined by analyzing the microphase separated structure. Specifically, as described in International Publication No. WO 2018/101252, half width X1 of a one-dimensional scattering profile in a small angle X ray scattering measurement is measured, and if the half width X1 is 0.05<X1<0.30, it may be determined that a physically cross-linked structure is formed.

The method of determining the presence of a physically cross-linked structure is not limited to the above method.

Meanwhile, to form a chemically cross-linked structure, examples of methods of forming a chemically cross-linked structure include a method in which a cross-linking agent which forms a chemically cross-linked structure including covalent bonds or ionic bonds by the reaction with cross-linkable functional groups existing in the molecule of the (meth)acrylic copolymer (A); a method in which a hydrogen abstracting photoinitiator is used to abstract hydrogen from the (meth)acrylic copolymer (A) to form a reaction site, thereby forming a cross-linked structure in and/or between molecules of the (meth)acrylic copolymer (A) or with other components of the composition; a method in which a photo-crosslinking agent (C) having one or more functional groups selected from the group consisting of an amino group, a hydroxyl group and a carboxyl group, in particular a multifunctional monomer having such a functional group, is combined with another cross-linking agent having a functional group which reacts with the functional group, for example, a cross-linking agent (B), which is more specifically an isocyanate compound (B1), to form a chemically cross-linked structure; and a method in which the functional group in the photo-crosslinking agent (C) is reacted with the functional group in the cross-linking agent (B), for example, the isocyanate group in the isocyanate compound (B1) to form a chemically cross-linked structure of the photo-crosslinking agents. However, the method is not limited thereto.

From the viewpoint of forming a cross-linked structure in the present adhesive sheet, preferred examples of the (meth)acrylic copolymers (A) include a (meth)acrylic copolymer comprising a graft copolymer having a macromonomer as a branch component, for example, a (meth)acrylic copolymer comprising a graft copolymer prepared by polymerizing a monomer mixture containing a macromonomer having a number average molecular weight of 500 or more and 100,000 or less and a vinyl monomer. These copolymers are preferred in that they are capable of forming a physically cross-linked structure in the present adhesive sheet.

Furthermore, a (meth)acrylic copolymer (A) having one or more functional groups selected from the group consisting of an amino group, a hydroxyl group and a carboxyl group, which can form a chemically cross-linked structure by the reaction with a functional group in a cross-linking agent (B), e.g., an isocyanate group, is preferred in that it is capable of forming a chemically cross-linked structure in the present adhesive sheet.

Furthermore, from the viewpoint of forming a chemically cross-linked structure by the reaction with the cross-linking agent (B) as described above, it is preferable that when an isocyanate compound (B1) is used as the cross-linking agent (B), the photo-crosslinking agent (C) has a functional group which reacts with the isocyanate compound (B1), for example, one or more functional groups selected from the group consisting of a hydroxyl group, a carboxyl group and an amino group.

Among them, the above multifunctional monomer having a chemical bond formed by one or more functional groups selected from the group consisting of a hydroxyl group, a carboxyl group and an amino group and an isocyanate group is preferred, because cohesive force of the adhesive composition can be increased.

Examples of such multifunctional monomers include multifunctional (meth)acrylates such as glycerol di(meth)acrylate, pentaerythritol tri(meth)acrylate, alkylene glycol-modified pentaerythritol tri(meth)acrylate, dipentaerythritol poly(meth)acrylate, alkylene glycol-modified di-pentaerythritol poly(meth)acrylate, isocyanuric acid EO-modified (meth)acrylate, various epoxy (meth)acrylates prepared by adding (meth)acrylic acid to a glycidyl ether compound and polyester (meth)acrylate.

In the present invention, whether a photocurable adhesive sheet has a cross-linked structure or not can be determined by measuring the gel fraction. When, for example, a photocurable adhesive sheet has a gel fraction of 5% or more, preferably 10% or more, the sheet can be determined to have a cross-linked structure. The method of determining whether the sheet has a chemical structure or not is not limited to such a method in which gel fraction is measured.

In this regard, the gel fraction may be measured by the following procedure.

1) The adhesive composition is weighed (W1) and wrapped in a SUS mesh of 200 mesh whose weight has been previously measured (WO).

2) The SUS mesh is immersed in 100 mL of ethyl acetate for 24 hours.

3) The SUS mesh is taken out and dried at 75° C. for 4 and a half hours.

4) The weight after drying (W2) is measured and gel fraction is determined by the following equation.

Gel fraction (%)=100×(W2−W0)/W1

### <Shape Retaining Properties and Photocurability>

It is preferable that the present adhesive has photocurability with the shape maintained.

Examples of cases in which the present adhesive sheet has photocurability while maintaining the shape as described above include cases in which the shape of the present adhesive sheet is maintained while the sheet is once cured (temporarily cured) and the sheet has photocurability (photoactivity) (referred to as “Mode 1”) and cases in which the shape of the present adhesive sheet is maintained while the sheet is uncured, or never cured and the sheet has photocurability (photoactivity) (referred to as “Mode 2”).

Examples of above Mode (1) include a method in which, in the production of the present adhesive sheet, the present adhesive sheet is temporarily cured (primarily cross-linked) to maintain the shape, while the sheet has photocurability (photoactivity).

A specific example of above Mode (1) may be to use, as the (meth)acrylic copolymer (A) containing 50% by mass or more of a structural unit represented by formula 1, a (meth)acrylic copolymer (A) having a functional group (i) which reacts with an isocyanate group in the isocyanate compound (B1), such as hydroxyl group, a carboxyl group and an amino group, when an isocyanate compound (B1) is used as the cross-linking agent (B). More specifically, the (meth)acrylic copolymer (A) may be a copolymer of any monomer component of a hydroxyl group-containing (meth)acrylate monomer, a carboxyl group-containing (meth)acrylate monomer and a nitrogen atom-containing (meth)acrylate monomer.

Then the functional group (i) in the (meth)acrylic copolymer (A) reacts with the isocyanate group (ii) in the isocyanate compound (B1) to form a chemical bond and thus the sheet is cured (cross-linked) to form an adhesive layer. Formation of the adhesive layer in that way enables the photo-crosslinking agent (C) and the photoinitiator (D) to exist in the adhesive layer while maintaining their activity.

At that stage, any of the above cleavage photoinitiator and the hydrogen abstracting photoinitiator may be used as the photoinitiator (D).

Furthermore, when a photo-crosslinking agent having one or more functional groups selected from the group consisting of an amino group, a hydroxyl group and a carboxyl group is used as the photo-crosslinking agent (C), and an isocyanate compound (B1) is used as the cross-linking agent (B), the functional group in the photo-crosslinking agent (C) reacts with the isocyanate group in the isocyanate compound (B1) to form a chemical bond and thus the sheet is cured (cross-linked) to form an adhesive layer.

In particular, formation of the adhesive layer using a photo-polymerizable compound having a carbon-carbon double bond in the molecule of the functional group as the photo-crosslinking agent (C) enables the photo-crosslinking agent (C) and the photoinitiator (D) to exist in the adhesive layer while maintaining their activity.

Furthermore, when an isocyanate compound (B1) is used as the cross-linking agent (B), the isocyanate compound (B1) may also have a radically polymerizable functional group such as a (meth)acryloyl group.

This allows an adhesive layer to be formed while maintaining photocurability (cross-linkability) of the (meth)acrylic copolymer (A) due to the radically cross-linkable functional group.

Particularly suitable examples of isocyanate compounds (B1) include 2-acryloyloxyethyl isocyanate, 2-methacryloyloxyethyl isocyanate and 1,1-(bisacryloyloxymethyl) ethyl isocyanate.

Utilizing cross-linking reaction in the (meth)acrylic copolymer (A) caused by the radically cross-linkable functional group is more preferred because it is advantageous in that cohesive force after photocuring (cross-linking) is efficiently increased and this is highly reliable.

Meanwhile, specific examples of the above Mode (2) include a method in which a macromonomer is used as a monomer component constituting the (meth)acrylic copolymer (A). More specifically, an example is a method in which a graft copolymer having a macromonomer as a branch component is used. When such a macromonomer is used, branch components are attracted to each other at room temperature so that the (meth)acrylic copolymer (A) forms a microphase separated structure, and the resin composition (adhesive) can maintain the state in which it is physically cross-linked, enabling the shape of the sheet to be maintained without being cured (cross-linked).

At that stage any of the above cleavage photoinitiator and the hydrogen abstracting photoinitiator may be used as the photoinitiator (D).

All of the above considered, particularly preferred embodiments of the present adhesive sheet include the following embodiments 1 to 3. However, the present adhesive sheet is not limited thereto.

Embodiment 1 of a preferred present adhesive sheet is an adhesive sheet comprising a photocurable adhesive composition comprising a (meth)acrylic copolymer (A) containing 50% by mass or more of a structural unit represented by the above formula 1, an isocyanate compound (B1), a photo-crosslinking agent (C) and a photoinitiator (D), wherein the photocurable adhesive sheet has a loss tangent (Tan δ) at a temperature of 90° C. of 0.9 or more and the (meth)acrylic copolymer (A) is a copolymer of any monomer component of a hydroxyl group-containing (meth)acrylate monomer, a carboxyl group-containing (meth)acrylate monomer and a nitrogen atom-containing (meth)acrylate monomer and any of a hydroxyl group, a carboxyl group and an amino group forms a chemical bond with an isocyanate group of the isocyanate compound (B1). The photo-crosslinking agent (C) and the photoinitiator (D) can exist in the adhesive sheet with their activity maintained.

Embodiment 2 of a preferred present adhesive sheet is an adhesive sheet comprising a photocurable adhesive composition comprising a (meth)acrylic copolymer (A) containing 50% by mass or more of a structural unit represented by the above formula 1, an isocyanate compound (B1), a photo-crosslinking agent (C) and a photoinitiator (D), wherein the photocurable adhesive sheet has a loss tangent (Tan δ) at a temperature of 90° C. of 0.9 or more and the photo-crosslinking agent (C) has one or more functional groups selected from the group consisting of a hydroxyl group, a carboxyl group and an amino group and a carbon-carbon double bond in the molecule, and the functional group forms a chemical bond with an isocyanate group in the isocyanate compound (B1). The photo-crosslinking agent (C) and the photoinitiator (D) can exist in the adhesive sheet with their activity maintained.

In the above embodiment, the photo-crosslinking agent (C) is preferably a multifunctional monomer having a hydroxyl group.

Embodiment 3 of a preferred present adhesive sheet is an adhesive sheet comprising a photocurable adhesive composition comprising a (meth)acrylic copolymer (A) containing 50% by mass or more of a structural unit represented by the above formula 1, an isocyanate compound (B1), a photo-crosslinking agent (C) and a photoinitiator (D), wherein the photocurable adhesive sheet has a loss tangent (Tan δ) at a temperature of 90° C. of 0.9 or more and the (meth)acrylic copolymer (A) is a copolymer of any monomer component of a hydroxyl group-containing (meth)acrylate monomer, a carboxyl group-containing (meth)acrylate monomer and a nitrogen atom-containing (meth)acrylate monomer and the photo-crosslinking agent (C) has one or more functional groups selected from the group consisting of an amino group, a hydroxyl group and a carboxyl group, and the adhesive sheet has a cross-linked structure in the (meth)acrylic copolymer (A). The photo-crosslinking agent (C) and the photoinitiator (D) can exist in the adhesive sheet with their activity maintained.

In the above embodiment, in particular, the photo-crosslinking agent (C) is preferably a multifunctional monomer having a hydroxyl group.

Furthermore, in the above embodiments, in particular, it is preferable that the (meth)acrylic copolymer (A) has a chemical bond formed between any of a hydroxyl group, a carboxyl group and an amino group, and an isocyanate group in the isocyanate compound (B1). It is also preferable that a chemical bond is formed between the functional group in the photo-crosslinking agent (C) and the isocyanate group in the isocyanate compound (B1).

### <Thickness>

The present adhesive sheet has a thickness of preferably 20 μm to 1 mm, more preferably 50 μm or more and 600 μm or less, and particularly preferably 75 μm or more and 500 μm or less.

### <Method for Producing Present Adhesive Sheet>

An example of methods for producing the present adhesive sheet will be described.

First, a photocurable adhesive composition is prepared. More specifically, the respective predetermined amount of a (meth)acrylic copolymer (A), a cross-linking agent (B) other than a photo-crosslinking agent, a photo-crosslinking agent (C), a photoinitiator (D), other materials, and the like are mixed to prepare a photocurable adhesive composition.

Methods of mixing them are not particularly limited, and the order of mixing of the components is not particularly limited. A heat treatment step may be additionally performed when producing the composition, and in that case, it is desired that the heat treatment is performed after mixing the components of the resin composition.

Alternatively, a masterbatch prepared by concentrating the components to be mixed may be used.

The apparatus when components are mixed is not particularly limited, and for example, a universal kneader, a planetary mixer, a Bunbury mixer, a kneader, a gate-type mixer, a pressure kneader, a triple roll and a double roll. The components may be mixed using a solvent where necessary.

The photocurable adhesive composition may be used in the form of a solvent-free composition containing no solvent. Using a solvent-free composition is advantageous in that heat resistance and light resistance are increased because no solvent remains.

The method of application (coating) is not particularly limited as long as it is a usual coating method, and examples thereof include roll coating, die coating, gravure coating, comma coating and screen printing.

For the method of forming a cross-linked structure in the present adhesive sheet, when a (meth)acrylic copolymer made of a graft copolymer having a macromonomer as a branch component is used as the above (meth)acrylic copolymer, main chains and/or graft chain components in the (meth)acrylic copolymer mutually cohere by the interaction such as a hydrogen bond, antistatic interaction and Van der Waals force, to form a physically cross-linked structure in the adhesive sheet.

Meanwhile, when a cross-linked structure is formed by the reaction of the cross-linking agent (B), the composition is appropriately heated or cured for a pre-determined period to form a chemically cross-linked structure in the adhesive sheet.

Alternatively, the photocurable resin composition is photo-cured by irradiating with light to form a cross-linked structure in the adhesive sheet while retaining photocurability.

It is preferable that for the composition to have photocurability, in other words, for the photoinitiator (D) to maintain photoactivity, the type of photoinitiators to be added, the region of wavelength of light with which the composition is irradiated, and the amount and the intensity of light are adjusted so that the gel fraction of the present adhesive sheet is 0 to 60%.

### <Physical Properties of Present Adhesive Sheet>

### (Loss Tangent (Tan δ))

The present adhesive sheet has a loss tangent (Tan δ) at a temperature of 90° C. of preferably 0.9 or more, more preferably 0.95 or more and 3.0 or less, and particularly preferably 1.0 or more and 2.5 or less.

Polymer materials usually have both viscous properties and elastic properties, and when the material has a Tan δ of 0.9 or more, and the value is larger, their viscous properties are enhanced.

Thus, the present adhesive sheet with such a property has high fluidity.

For the present adhesive sheet to have the above property, the present adhesive sheet is to be formed of the above photocurable resin composition.

Specifically, it is preferable to prepare the type and the amount of a raw material which generates a cross-linked structure, such as a cross-linking agent and a (meth)acrylate monomer so that the present adhesive sheet has fluidity on the molecular level at 90° C. without a complex cross-linked structure. However, the method is not limited thereto.

### (Light Transmittance and Haze)

It is preferable that the present adhesive sheet has a total light transmittance (JIS K7361-1) of 80% or more and a haze (JIS K7136) of 5% or less from the viewpoint of optical use such as being used as a member constituting an image display device.

The present adhesive sheet has a total light transmittance of preferably 80% or more, and more preferably 90% or more from the above viewpoint. Furthermore, the present adhesive sheet has a haze of 5% or less, and more preferably 2% or less.

### (Durability of Shape Retaining Force)

It is preferable that the drop time of the present adhesive sheet when the shape retaining force is measured by applying a load of 1 N/cm² thereto at 40° C. is 60 minutes or more.

The present adhesive sheet with such a property is advantageous in that storage stability and high operationability can be obtained.

From the above viewpoint, the length of dislocation after 60 minutes is preferably 10 mm or less, more preferably 5 mm or less, and further preferably 3 mm or less.

It is also preferable that the drop time of the present adhesive sheet when the shape retaining force is measured by applying a load of 1 N/cm² thereto at 60° C. is within 60 minutes.

The present adhesive sheet with such properties is advantageous in that the sheet has excellent wettability to a member to be bonded and exhibit excellent step absorbing properties. Furthermore, the present adhesive sheet with such properties is applicable to hot melt bonding.

### (Peeling Strength)

The present adhesive sheet has a 180° peeling strength to glass before photoirradiation of preferably 1 N/cm or more, and more preferably 2 N/cm or more.

The present adhesive sheet with such a property is advantageous in that positioning is easy when the present adhesive sheet is bonded to a member to be bonded.

The present adhesive sheet has a 180° peeling strength to glass of preferably 3 N/cm or more, and more preferably 4 N/cm or more when the present adhesive sheet is attached to glass and irradiated with light in an accumulated exposure of 2,000 mJ/m².

The present adhesive sheet with such properties is advantageous in that the sheet is highly durable.

For the present adhesive sheet to have the above property, the present adhesive sheet is to be formed of the above photocurable resin composition.

### <<Another Embodiment>>

A photocurable adhesive sheet according to another embodiment of the present invention (referred to as “present adhesive sheet 2”) is a photocurable adhesive sheet formed of a photocurable adhesive composition (referred to as “present adhesive composition 2”) comprising a (meth)acrylic copolymer (A), a photo-crosslinking agent (C) and a photoinitiator (D), wherein the photocurable adhesive sheet has a chemically cross-linked structure and has a loss tangent (Tan δ) at a temperature of 90° C. of 0.9 or more.

The (meth)acrylic copolymer (A), the photo-crosslinking agent (C) and the photoinitiator (D) in present adhesive composition 2 are the same as the (meth)acrylic copolymer (A), the photo-crosslinking agent (C) and the photoinitiator (D) in the present adhesive composition described above.

Furthermore, the above and following description of the present adhesive composition and the present adhesive sheet is applicable to present adhesive composition 2 and present adhesive sheet 2.

### <<Present Adhesive Sheet Laminate>>

An adhesive sheet laminate according to an embodiment of the present invention (hereinafter referred to as “the present adhesive sheet laminate”) has a structure in which the present adhesive sheet and a release film are stacked.

For the material of the release film, a known release film may be appropriately used. For example, a release film prepared by mold release treatment by applying silicone resin to film such as a polyester film, a polyolefin film, a polycarbonate film, a polystyrene film, an acrylic film, a triacetyl cellulose film or a fluorine resin film, or a release paper may be selected and used.

When the release film is stacked on both sides of the present adhesive sheet, the structure of stacking and the material of the release film on one side may be the same as or different from those of the release film on the other side.

The thickness may also be the same or different.

A release film having a different peeling strength or a release film having a different thickness may be stacked on both sides of the present adhesive sheet.

The thickness of the release film is not particularly limited. Among them, from the viewpoint of processability and handleability, the release film has a thickness of preferably 25 μm to 500 μm, more preferably 38 μm or more and 250 μm or less, and further preferably 50 μm or more and 200 μm or less.

For the present adhesive sheet, a method of directly extrusion-molding the above resin composition without using a member to be bonded or release film as described above, or a method of molding by injecting into a mold may also be employed.

Furthermore, the space between members constituting an image display device, which are a member to be bonded, may be directly filled with the resin above composition to form the present adhesive sheet.

### <<Present Laminate for Image Display Device>>

A laminate for an image display device according to an embodiment of the present invention (hereinafter referred to as “the present laminate for an image display device”) has a structure in which the present adhesive sheet is inserted between two members constituting an image display device.

Examples of members constituting an image display device include a combination of two or more selected from the group consisting of a touch sensor, an image display screen, a surface protection screen, a polarizing film and a retardation film.

Specific examples of structures of the present laminate for an image display device include: release film/present adhesive sheet/touch screen, image display screen/present adhesive sheet/touch screen, image display screen/present adhesive sheet/touch screen/present adhesive sheet/protection screen, polarizing film/present adhesive sheet/touch screen, and polarizing film/present adhesive sheet/touch screen/present adhesive sheet/protection screen.

The above touch screen includes a structure having the function of a touch screen built-in a protection screen and a structure having the function of a touch screen built-in an image display screen.

Thus, the present laminate may have a structure of, for example, release film/present adhesive sheet/protection screen, release film/present adhesive sheet/image display screen, and image display screen/present adhesive sheet/protection screen.

Examples of the constitutions also include all of those in which a conductive layer is inserted between the present adhesive sheet and a member adjacent thereto, such as a touch screen, a protection screen, an image display screen and a polarizing film.

Examples of the touch screens include a resistive film type, a capacitance type and an electromagnetic induction type. Of them, a capacitance type is preferred.

Materials of the above protection screen include glass and plastics such as an acrylic resin, a polycarbonate resin, an alicyclic polyolefin resin such as cycloolefin polymer, a styrene resin, a polyvinyl chloride resin, a phenol resin, a melamine resin and an epoxy resin.

An image display screen is composed of a polarizing film, other optical films such as a retardation film, a liquid crystal material and a backlight system (usually an optical film is on the adhesive side of a composition for forming an adhesive layer or an adhesive article to be bonded to an image display screen). The type of image display screens includes an STN type, a VA type and an IPS type depending on the method of controlling liquid crystal materials, and any of them may be used.

The present laminate for an image display device may be used as a member constituting an image display device, such as a liquid crystal display, an organic EL display, an inorganic EL display, electronic paper, a plasma display and a micro-electro-mechanical system (MEMS) display.

<<Present image display device>>

An image display device according to an embodiment of the present invention (referred to as “the present image display device”) comprises the present laminate for an image display device.

Specific examples of present image display devices include a liquid crystal display, an organic EL display, an inorganic EL display, electronic paper, a plasma display and a micro-electro-mechanical system (MEMS) display, comprising the present laminate for an image display device.

### <<Description of Terms>>

As used herein, the expression “X to Y” (X and Y are any number) means “X or more and Y or less,” also including the meaning: “preferably more than X” and “preferably less than Y” unless otherwise specified.

Furthermore, the expressions “X or more” (X is any number) and “Y or less” (Y is any number) also includes the meaning: “preferably more than X” and “preferably less than Y.”

In the present invention, the term “film” includes “sheet,” and the term “sheet” includes “film.”

### EXAMPLES

In the following, the present invention will be described in more detail with reference to Examples and Comparative Examples. However, the present invention is not limited to these Examples.

### Example 1

20 g of a blocked isocyanate compound (B-1, “MF-B60B” manufactured by Asahi Kasei Corporation), 150 g of propoxylated pentaerythritol triacrylate (C-1, “NK ester ATM-4PL” manufactured by SHIN-NAKAMURA CHEMICAL CO., LTD.), which is a photo-crosslinking agent, and 15 g of a mixture of 2,4,6-trimethylbenzophenone and 4-methylbenzophenone (D-1, “Esacure TZT” made by IGM), which is a photoinitiator, were added to 1 kg of an acrylic graft copolymer (A-1, mass average molecular weight: 250,000), which is a (meth)acrylic copolymer prepared by random copolymerization of 15 parts by mass of a macromonomer (number average molecular weight: 3,000) which is composed of methyl methacrylate and whose terminal functional group is a methacryloyl group, 86 parts by mass of butyl acrylate and 4 parts by mass of acrylic acid. The mixture was mixed until homogeneous to give an adhesive composition 1.

Next, the adhesive composition 1 was molded on a polyethylene terephthalate film whose surface had been subjected to peeling treatment (“DIAFOIL MRV (V08)” made by Mitsubishi Chemical Corporation, thickness 100 μm) in the form of sheet so that the thickness was 120 μm. Then this was covered with a polyethylene terephthalate film whose surface had been subjected to peeling treatment (“DIAFOIL MRQ” made by Mitsubishi Chemical Corporation, thickness 75 μm). This was heated at 120° C. for 30 minutes and cured for a week at room temperature to cross-link isocyanate to give an adhesive sheet 1.

The adhesive sheet 1 has a chemically cross-linked structure formed from isocyanate and has photocurability, which is to be cured (cross-linked) by irradiating with light.

### Example 2

An adhesive composition 2 and an adhesive sheet 2 were prepared in the same manner as in Example 1 except for using 40 g of the isocyanate compound (B-1).

The adhesive sheet 2 also has a chemically cross-linked structure formed from isocyanate and has photocurability, which is to be cured (cross-linked) by irradiating with light.

### Example 3

An adhesive composition 3 and an adhesive sheet 3 were prepared in the same manner as in Example 1 except for using 80 g of the isocyanate compound (B-1).

Adhesive sheet 3 also has a chemically cross-linked structure formed from isocyanate and has photocurability, which is to be cured (cross-linked) by irradiating with light.

### Example 4

20 g of a blocked isocyanate compound (B-1, “MF-B60B” manufactured by Asahi Kasei Corporation), 125 g of dipentaerythritol polyacrylate (“A9570W” manufactured by SHIN-NAKAMURA CHEMICAL CO., LTD.) and 25 g of pentaerythritol tri- and tetraacrylate (“A-TMM3-L” manufactured by SHIN-NAKAMURA CHEMICAL CO., LTD.), which is a photo-crosslinking agent (C-2), and 20 g of a mixture of 2,4,6-trimethylbenzoyl-diphenyl-phosphine oxide, oligo(2-hydroxy-2-methyl-1-(4-1-methylvinyl)phenyl)propanone), 2,4,6-trimethylbenzophenone and 4-methylbenzophenone (“Esacure KT046” manufactured by IGM), which is a photoinitiator (D-2), which is a photoinitiator (D-2), were added to 1 kg of an acrylic graft copolymer (A-2, mass average molecular weight: 250,000), which is a (meth)acrylic copolymer prepared by random copolymerization of 14.8 parts by mass of a macromonomer (number average molecular weight: 3,000) which is composed of isobornyl methacrylate:methyl methacrylate=1:1 and whose terminal functional group is a methacryloyl group, 73.3 parts by mass of 2-ethylhexyl acrylate, 8.8 parts by mass of methyl acrylate and 3.1 parts by mass of acrylamide. The mixture was mixed until homogeneous to give an adhesive composition 4.

Next, the adhesive composition 4 was molded on a polyethylene terephthalate film whose surface had been subjected to peeling treatment (“DIAFOIL MRV (V08)” manufactured by Mitsubishi Chemical Corporation, thickness 100 μm) in the form of sheet so that the thickness was 120 μm. Then this was covered with a polyethylene terephthalate film whose surface had been subjected to peeling treatment (“DIAFOIL MRQ” manufactured by Mitsubishi Chemical Corporation, thickness 75 μm). This was heated at 120° C. for 30 minutes and cured for a week at room temperature to cross-link isocyanate to give an adhesive sheet 4.

The adhesive sheet 4 also has a chemically cross-linked structure formed from isocyanate and has photocurability, which is to be cured (cross-linked) by irradiating with light.

### Example 5

An adhesive composition 5 and an adhesive sheet 5 were prepared in the same manner as in Example 4 except for using 80 g of the isocyanate compound (B-1).

The adhesive sheet 5 also has a chemically cross-linked structure formed from isocyanate and has photocurability, which is to be cured (cross-linked) by irradiating with light.

### Comparative Example 1

An adhesive composition 6 and an adhesive sheet 6 were prepared in the same manner as in Example 1 except for not using the isocyanate compound.

### Comparative Example 2

As an adhesive composition 7, an acrylic adhesive (“SK-Dyne 1882” manufactured by Soken Chemical & Engineering Co., Ltd., to which a curing agent was added at a recommended ratio) was molded on a polyethylene terephthalate film whose surface had been subjected to peeling treatment (“DIAFOIL MRV (V08)” manufactured by Mitsubishi Chemical Corporation, thickness 100 μm) in the form of sheet so that the thickness after drying was 30 μm to form an adhesive layer. Four pieces of the adhesive layer were stacked using a hand roller and then this was covered with a polyethylene terephthalate film whose surface had been subjected to peeling treatment (“DIAFOIL MRQ” manufactured by Mitsubishi Chemical Corporation, thickness 75 μm).

This was treated in an autoclave under conditions of a temperature of 60° C., 0.2 MPa and 20 minutes, and the cross-linking agent was allowed to react by curing at room temperature for 1 week to prepare an adhesive sheet 7.

### Comparative Example 3

60 g of nonanediol diacrylate (C-3, “Biscoat260” manufactured by Osaka Organic Chemical Industry Co., Ltd.), which is a multifunctional monomer, and 10 g of a mixture of 2,4,6-trimethylbenzophenone and 4-methylbenzophenone (D-1, “Esacure TZT” manufactured by IGM), which is a photoinitiator, were added to 1 kg of an acrylic copolymer (A-3, mass average molecular weight: 490,000) prepared by random copolymerization of 72 parts by mass of butyl acrylate, 26 parts by mass of 2-ethylhexyl acrylate and 2 parts by mass of acrylic acid. The mixture was mixed until homogeneous to give a composition for forming an adhesive layer 8.

Next, the adhesive composition 8 was molded on a polyethylene terephthalate film whose surface had been subjected to peeling treatment (“DIAFOIL MRV (V08)” manufactured by Mitsubishi Chemical Corporation, thickness 100 μm) in the form of sheet so that the thickness was 120 μm. Then this was covered with a polyethylene terephthalate film whose surface had been subjected to peeling treatment (“DIAFOIL MRQ” manufactured by Mitsubishi Chemical Corporation, thickness 75 μm).

The adhesive composition was photo-cured by irradiating the adhesive sheet with light with a wavelength of 365 nm through the release film using a high pressure mercury lamp in an accumulated exposure of 2,000 mJ/m² to prepare an adhesive sheet 8.

### <Evaluation>

The respective sheets and other materials prepared in Examples and Comparative Examples were evaluated as follows.

The results of evaluation are shown in Table 1.

(1) Measurement of Viscosity

The release film in the adhesive sheets 1 to 8 was removed and the adhesive sheet was stacked to have a thickness of 1 mm or more. Then, dynamic viscoelasticity was measured by using a rheometer (“MARS” manufactured by EKO Instruments Co., Ltd.) under conditions of using a tool for adhesive: ϕ 20 mm parallel plate, strain: 0.5%, frequency 1 Hz, and temperature increase rate: 3° C./minute to determine loss tangent (Tan δ) at a temperature of 90° C.

(2) Optical Properties

One of the release films on the adhesive sheets 1 to 8 prepared in Examples and Comparative Examples was removed, and soda-lime glass having a size of 82 mm×53 mm and a thickness of 0.55 mm was bonded to the adhesive surface exposed by a hand roller.

The remaining release film was removed and soda-lime glass having a size of 82 mm×53 mm and a thickness of 0.55 mm was bonded to the adhesive surface exposed by a hand roller to prepare a sample for evaluating optical properties.

The haze was measured according to JIS K7136 using a haze meter (NDH5000 manufactured by NIPPON DENSHOKU INDUSTRIES Co., Ltd.) and the total light transmittance was measured according to JIS K7361-1.

(3) Dimensional Stability

The adhesive sheets 1 to 8 prepared in Examples and Comparative Examples were cut halfway on the side of one of the release film (“DIAFOIL MRQ” manufactured by Mitsubishi Chemical Corporation, thickness 75 μm) in a square of 30 mm×30 mm so as not to pierce through the other release film (“DIAFOIL MRV (V08)” manufactured by Mitsubishi Chemical Corporation, thickness 100 μm).

One of the release film which was cut (“DIAFOIL MRQ” manufactured by Mitsubishi Chemical Corporation, thickness 75 μm) was peeled off, and the adhesive surface exposed was covered with a polyethylene terephthalate film which had been subjected to release treatment (“DIAFOIL MRT” manufactured by Mitsubishi Chemical Corporation, thickness 50 μm).

The release films on both sides were cut into 50 mm×50 mm to prepare a sample for evaluating dimensional stability before photocuring.

The sample for evaluating dimensional stability was cured in an environment of a temperature of 40° C. and a humidity of 90% for 300 hours, and the amount of overflow of adhesive at the edge of the adhesive sheet after curing was observed.

For the amount of overflow of adhesive, the length of overflow of adhesive at the center of the respective lines of the adhesive sheet which had been cut and cured was measured, and the average length of the four lines was determined as the amount of overflow of adhesive (mm).

Adhesive sheets which were out of shape after curing and in which the amount of overflow of adhesive was 1 mm or more were rated as “X (poor)” and those in which overflow of adhesive was observed but the amount was less than 1 mm were rated as “◯ (good).”

In the table, “<0.1 mm” means that the amount of overflow of adhesive is less than 0.1 mm with almost no overflow of adhesive.

(4) Step Absorbing Properties

Printing was carried out in a thickness of 30 to 35 μm on the periphery of a piece of glass having a size of 58 mm×110 mm and a thickness of 0.2 mm to prepare a glass plate with a printed step having a recess of 52 mm×80 mm at the center.

The adhesive sheets 1 to 8 prepared in Examples and Comparative Examples were cut into a size of 52 mm×81 mm. One of the release films was removed and soda-lime glass (54 mm×82 mm×0.5 mm in thickness) was bonded to the sheet by a roller. Then the remaining other release film was removed, and the adhesive sheet was vacuum-pressed to the glass plate with a printed step so that the adhesive sheet covered the entire periphery of the frame-shaped printed step of the glass plate using a vacuum press (temperature 25° C., pressing pressure 0.13 MPa, pressing time 1 minute) to prepare a sample for evaluation.

The sample for evaluation was treated in an autoclave under conditions of 40° C., 0.2 MPa and 20 minutes, and then evaluated on a pass/fail basis according to the following evaluation criteria.

◯ (good): No separation or small foam on the periphery of step

x (poor): separation and small foam found on the periphery of step

(5) Reliability in heat and humidity

### <Constitution of Lamination of Glass Plate>

For the samples used for evaluating step absorbing properties, the adhesive sheets 1 to 8 were irradiated with light with a wavelength of 365 nm from the side of the glass plate with a printed step using a high pressure mercury lamp in an accumulated exposure of 2,000 mJ/m² to prepare a sample for evaluating durability.

The sample for evaluation was exposed to a condition of 85° C. and 85% R.H. for 24 hours. Those whose appearance is defect-free were rated as “⊚ (very good),” those with flow of the adhesive sheet under the printing and deformation at the edge of the adhesive sheet were rated as “◯ (good)” and those with foam and peeling in the opening near the printed step were rated as “x (poor).”

### <Constitution of Lamination of Resin Plate>

The release film in the adhesive sheets 1 to 8 prepared in Examples and Comparative Examples was removed and polyethylene terephthalate film (“COSMOSHINE A4300” manufactured by TOYOBO Co., Ltd.) was press-bonded to the surface exposed by a hand roller.

This was cut into 45 mm×90 mm and the adhesive surface which was exposed by removing the remaining release film was bonded to the side of polycarbonate resin of a polycarbonate resin plate (“lupilon sheet MR 58” manufactured by Mitsubishi Gas Chemical Company, 50 mm×100 mm, thickness 0.8 mm) by using a hand roller to prepare a sample for evaluation.

The sample for evaluation was exposed to a condition of 85° C. and 85% R.H. for 24 hours. Those whose appearance was defect-free without foam or peeling was rated as “◯ (good),” and those with foam and/or peeling were rated as “x (poor).”

TABLE 1

| | | Example | | | | | Comparative Example | | |
|---|---|---|---|---|---|---|---|---|---|
| | | 1 | 2 | 3 | 4 | 5 | 1 | 2 | 3 |
| (Meth)acrylic copolymer | A-1 | 100 | 100 | 100 | — | — | — | Acrylic | — |
| | A-2 | — | — | — | 100 | 100 | 100 | adhesive | — |
| | A-3 | — | — | — | — | — | — | | 100 |
| Isocyanate | B-1 | 2 | 4 | 8 | 2 | 8 | — | | — |
| Photo-crosslinking agent | C-1 | 15 | 15 | 15 | — | — | — | | — |
| | C-2 | — | — | — | 15 | 15 | 15 | | — |
| | C-3 | — | — | — | — | — | — | | 6 |
| Photoinitiator | D-1 | 1.5 | 1.5 | 1.5 | — | — | — | | 1 |
| | D-2 | — | — | — | 2 | 2 | 2 | | — |
| 90° C. Tanδ | | 1.1 | 1.4 | 2.0 | 1.8 | 1.7 | 2.1 | 0.2 | 0.2 |
| Dimensional stability | 40° C. 300 h | 0.3 mm | 0.1 mm | <0.1 mm | 0.3 mm | 0.1 mm | 1.0 mm | <0.1 mm | 0.3 mm |
| | | ◯ | ◯ | ◯ | ◯ | ◯ | X | ◯ | ◯ |
| Step absorbing properties | 35-40μ | ◯ | ◯ | ◯ | ◯ | ◯ | ◯ | X | ◯ |
| Reliability | 85° C. 85% | ⊚ | ⊚ | ⊚ | ⊚ | ⊚ | ◯ | X | X |

| | | | | | | | | |
|---|---|---|---|---|---|---|---|---|
| Comprehensive evaluation | ◯ | ◯ | ◯ | ◯ | ◯ | X | X | X |

The result is that the adhesive sheets of Examples have a loss tangent (Tan δ) at a temperature of 90° C. of 0.9 or more and have not only excellent step absorbing properties and reliability in heat and humidity, but also excellent dimensional stability because the isocyanate compound provides storage stability.

Furthermore, portions of the adhesive sheet on the printed part, which are difficult to be cured because light is difficult to reach them, do not flow out in the durability test, maintaining the fixed shape.

By contrast, the adhesive sheet of Comparative Example 1, which is formed of only a hot-melt adhesive composition and does not include a cross-linking agent such as isocyanate, has poor dimensional stability.

Furthermore, in the reliability test of the structure of lamination of a glass plate, the adhesive sheet under the print flowed, causing overflow of adhesive at the edge.

The adhesive sheet of Comparative Example 2, which is not photo-crosslinkable, has a loss tangent (Tan δ) at a temperature of 90° C. of less than 0.9 and is composed of only a highly cohesive adhesive layer, has good dimensional stability but has poor step absorbing properties.

The adhesive sheet of Comparative Example 3, which is not hot-melting, has a loss tangent (Tan δ) at a temperature of 90° C. of less than 0.9 and is composed of only a soft adhesive layer, has low cohesive force and foamed in the durability test of the structure of lamination of a resin plate, and thus is not reliable.

1. A photocurable adhesive sheet, comprising:
a photocurable adhesive composition comprising a (meth)acrylic copolymer (A),
a cross-linking agent (B) other than a photo-crosslinking agent,
a photo-crosslinking agent (C), and
a photoinitiator (D),
wherein the photocurable adhesive sheet has a loss tangent (Tan δ) at a temperature of 90° C. of 0.9 or more.

2. The photocurable adhesive sheet according to claim 1, having a physically and/or chemically cross-linked structure.

3. The photocurable adhesive sheet according to claim 1, having a cross-linked structure formed by a reaction of the (meth)acrylic copolymer (A) and the cross-linking agent (B), a cross-linked structure formed by a reaction of the cross-linking agent (B) and the photo-crosslinking agent (C), or both.

4. The photocurable adhesive sheet according to claim 1, wherein the (meth)acrylic copolymer (A) is a copolymer of a monomer component comprising a hydrophilic (meth)acrylate monomer.

5. The photocurable adhesive sheet according to claim 1, wherein the (meth)acrylic copolymer (A) has at least one functional group selected from the group consisting of a hydroxyl group, a carboxyl group and an amino group, and in the adhesive sheet, the at least one functional group forms a chemical bond with a functional group in the cross-linking agent (B).

6. The photocurable adhesive sheet according to claim 1, wherein the photo-crosslinking agent (C) is a multifunctional monomer.

7. The photocurable adhesive sheet according to claim 1, wherein the photo-crosslinking agent (C) has at least one functional group selected from the group consisting of a hydroxyl group, a carboxyl group and an amino group, and in the adhesive sheet, the at least one functional group forms a chemical bond with a functional group in the cross-linking agent (B).

8. The photocurable adhesive sheet according to claim 1, wherein the (meth)acrylic copolymer (A) is a graft copolymer obtained by polymerizing a monomer mixture comprising a macromonomer having a number average molecular weight of 500 or more and 100,000 or less and a vinyl monomer.

9. The photocurable adhesive sheet according to claim 1, wherein the cross-linking agent (B) is an isocyanate compound, which is a blocked isocyanate an isocyanate group protected by a blocking agent comprising any or two or more of a phenol compound, a caprolactam compound, an oxime compound and an active methylene compound.

10. A photocurable adhesive sheet, comprising:
a photocurable adhesive composition comprising a (meth)acrylic copolymer (A),
a photo-crosslinking agent (C), and
a photoinitiator (D),
wherein the photocurable adhesive sheet has a chemically cross-linked structure and has a loss tangent (Tan δ) at a temperature of 90° C. of 0.9 or more.

11. The photocurable adhesive sheet according to claim 10, wherein the (meth)acrylic copolymer (A) is a copolymer of a monomer component comprising a hydrophilic (meth)acrylate monomer.

12. The photocurable adhesive sheet according to claim 10, wherein the photo-crosslinking agent (C) is a multifunctional monomer.

13. The photocurable adhesive sheet according to claim 10, wherein the (meth)acrylic copolymer (A) is a graft copolymer obtained by polymerizing a monomer mixture comprising a macromonomer having a number average molecular weight of 500 or more and 100,000 or less and a vinyl monomer.

14. A laminate for an image display device, comprising a structure in which the photocurable adhesive sheet according to claim 1 is inserted between two members constituting an image display device.

15. The laminate for an image display device according to claim 14, wherein the member constituting an image display device is a laminate comprising a combination of two or more selected from the group consisting of a touch sensor, an image display screen, a surface protection screen, a polarizing film and a retardation film.

16. An image display device comprising the laminate for an image display device according to claim 14.
